(19) United States
(12) Patent Application Publication
(10) Pub. No.: US 2007/0253193 A1
(43) Pub. Date: Nov. 1, 2007

(54) RETRO-FIT SYSTEM FOR NON-INSULATED CEILING CAN LIGHT FIXTURE

(76) Inventor: Kenneth Lau, Carlsbad, CA (US)

Correspondence Address: STEVEN W. WEBB, 655 2ND STREET, ENCINITAS, CA, 92024, US

(21) Appl. No.: 11/741,676

(22) Filed: Apr. 27, 2007

Related U.S. Application Data
(60) Provisional application No. 60/795,826, filed on Apr. 29, 2006.

(51) Int. Cl. F21S 8/00

(52) U.S. Cl. 362/147

(57) ABSTRACT

An improved ceiling light fixture reflector is presented where the reflector is completely sealed to prevent any heated air from escaping through the fixture or its surrounds. The reflector also prevents cooled air from air conditioning from escaping through the fixture apertures. This improved insulation of ceiling lighting fixtures helps to eliminate the conversion of snow into ice on the surface of roofs due to the escape of moist, heated air through the ceiling and then to the roof, where it freezes into ice and expands thereby cracking the roof.

During warmer months, this improved airtight lighting fixture also reduces cooled air losses and improves the air conditioning efficiency of buildings and saves energy.

### RELATED APPLICATIONS

This application extends and completes Provisional Patent Application 60/795,826, filed on Apr. 29, 2006.

### FIELD OF THE INVENTION

This invention is related to the field of ceiling-mounted lighting fixtures, including “cans” recessed behind the ceiling panels, and surface mounted fixtures similar in lighting function and external appearance to can mounts but not necessarily recessed.

### BACKGROUND OF THE INVENTION

This invention is a follow-on to several earlier inventions by this inventor, contained in U.S. Pat. Nos. 5,597,233 and 6,350,046. These two patents teach a lighting system designed for industrial ceilings that have air apertures in the lighting can housings, allowing heat generated by the lamps to pass upwards through the can and into the ceiling area above.

The majority of can light fixtures installed in the United States are not insulated at all, and even the minority of “insulated” cans containing down lights have been classified as non-insulated (non-IC cans).

When incandescent lights are used in down light fixtures, the venting apertures in the can housings amplifies the chimney effect of heat rising up through the cans. To prevent fires in insulated ceilings, insulation materials must be kept at least three inches away from the can housings. This reduces the effectiveness of the insulation in keeping building heat below the ceiling.

Loss of heated air through the lighting cans exacerbates a common problem that roofs have during the winter; that is, the snow on the roof melted by moist, hot air from the ceiling rising through the roof causing the snow to turn into ice, which expands and cracks the roof. Replacing incandescent bulbs in down lighting with fluorescent bulbs reduces heat generation by 75% and reduces the moist hot air loss through the roof. Retrofitting incandescent and florescent down lighting cans with the present invention will eliminate heated air loss through the cans entirely and prevent expensive roof damages.

### SUMMARY OF THE INVENTION

Reduction in air loss through the cans also reduces the loss of cooled air from air conditioning during the warmer months, reducing energy usage to cool building air.

The present invention is a retrofit of the existing lighting can designs produced by the present inventor as well as standard lighting cans. Using the present invention, the air cooling apertures in the can housing do not need to be plugged and a vent-free reflector and trim assembly can be mounted in the can housing. This system can also use a compact fluorescent light bulb that produces substantially less heat than an incandescent bulb.

By preventing the leaking of heated air through the top of the can housing, the ceiling can be more effectively insulated and the insulation can be extended all the way to the outer surface of the can housing and can be placed in contact with the can housing itself without fear of fire.

The preferred embodiment of the present invention includes a ballast for a fluorescent lamp or lamps in the trim rim of the reflector, permitting the use of a fluorescent lamp. An alternate embodiment of the invention possesses no ballast in the trim rim and is independent of the presence or absence of any ballast, This embodiment can be applied to an incandescent bulb fixture as well as a fluorescent fixture.

### OBJECTS OF THE INVENTION

It is an object of the present invention to provide an airtight reflector system that can be retrofitted to existing non-insulated can lighting fixtures that eliminates heated air loss through the cans into the ceiling.

It is a further object of the present invention to provide such a reflector system with a trim rim that extends outside of and surrounds the existing non-insulated can.

It is a further object of the present invention to provide a trim rim in two configurations, with a ballast and without a ballast.

### BRIEF DESCRIPTION OF THE FIGURES

FIG. 1. Non-Insulated Can With Air Vents in Insulated Celling

FIG. 2. Non-Insulated Can With Air Vents in Non-Insulated Ceiling With Retrofit Reflector

FIG. 3. Perspective View of Retrofit Reflector

FIG. 4. Cross-section of the Invention

### DETAILED DESCRIPTION

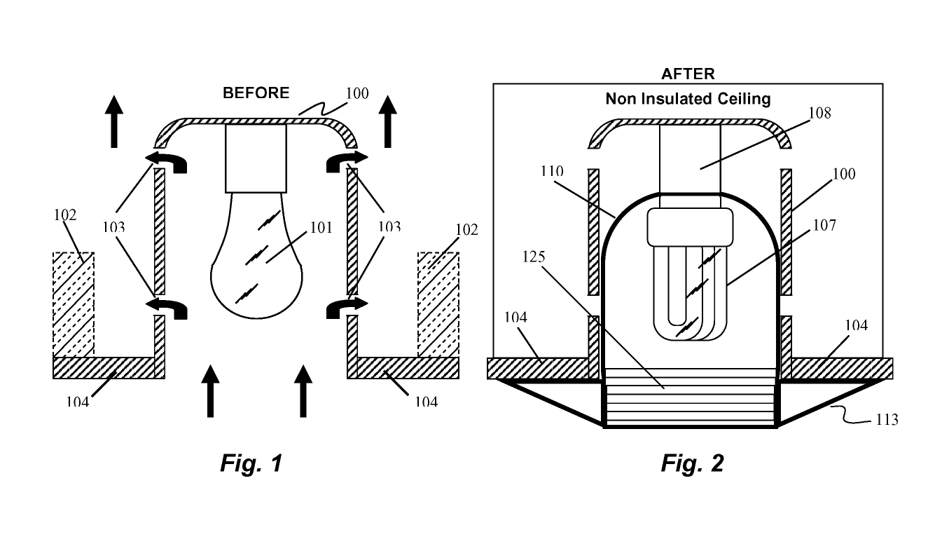

FIG. 1 shows a cross-section view of a typical recessed ceiling non-insulated can (non-IC) 100 with incandescent lamp 101 installed in lampholder 108 inside the non-IC, insulating material 102 surrounding the non-IC 100 at a distance of at least three inches and heated air vents 103. The non-IC 100 loses air through the air vents 103, which heat loss intended to keep the air temperature inside the non-IC 100 below the acceptable maximum for operation of the incandescent lamp 101 and to thereby prevent fires. Even though the ceiling is itself insulated, there is substantial heat loss through the lighting can.

FIG. 2 shows the application of the present invention 110 to the non-IC 100 in a non-insulated ceiling 104, with compact fluorescent lamp 107, light baffle 125, and incandescent lampholder 108. Heated air loss is unobstructed through the air vents 103. In FIG. 2, the lampholder 108 is shown as separate from the invention 110, such that the invention 110 can be installed in the non-IC 100 as shown, surrounding the fluorescent lamp 107.

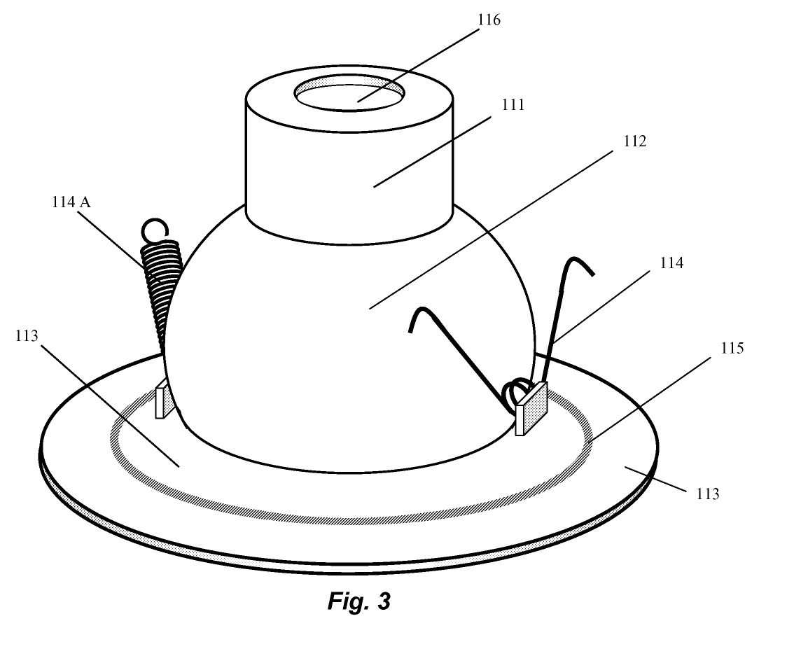

The present invention 110 incorporates a reflector assembly with the option of a baffle 125 serving as a glare shield, with aperture 116 (shown in FIG. 3) for mating with incandescent lampholder 108, with optional gasket 115 to further seal the reflector and lampholder connection to prevent air leakage. This is an alternate embodiment of the invention.

In FIG. 3, the invention 110 is shown, consisting of an aperture 116, a no-vent reflector 112, a trim-rim 113, a plurality of spring clips 114, 114A and an optional silicon rubber gasket 115. The invention 110 is shown as roughly cylindrical in shape, but the invention 110 can be made in a number of shapes with or without aperture for lamps to meet the shapes of standard lighting fixtures in use today.

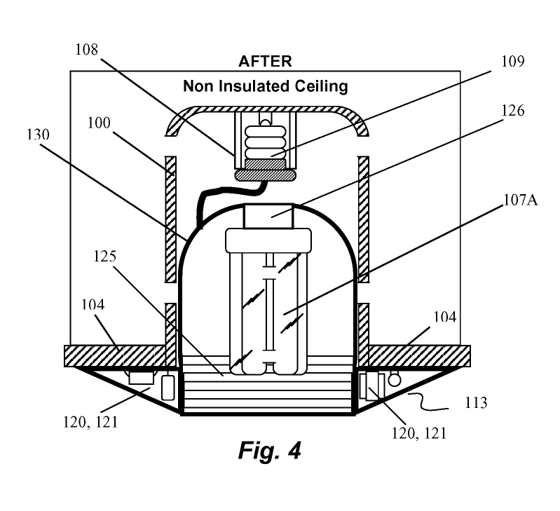

In FIG. 4, the cross-section of the preferred embodiment of the invention shows a power control device 120 and sensors 121 inside the hollow trim rim 113. The original can's 100 incandescent lampholder 108 is used to make the electrical connection by means of adaptor 109. This is the preferred embodiment of the invention.

The invention is installed by removing the incandescent lamp 101 from its socket within a non-IC 100, placing the invention 110 below the socket by means of connecting the adaptor 109 end of the invention to the socket, fitting the trim rim to the hole in the ceiling where the non-IC 100 is placed by pushing the invention 110 up into the can 110 until the trim rim 113 meets the bottom surface of the ceiling 104, and then inserting a replaceable CFI 107A in the socket 126. Where the bottom surface of the ceiling is irregular, there is an additional step of placing an optional silicon rubber gasket 115 between the trim rim and the bottom surface of the ceiling. The invention 110 is attached to the can 100 by means of V-shaped tensions springs 114 or coiled springs 114A.

While the foregoing describes a preferred and an alternative embodiment of the invention, variation on this design and equivalent designs may be resorted to in the scope and spirit of the claimed invention.

What is claimed is:

1. a ceiling lighting retrofit system, the retrofit system comprised of a reflector and a trim rim,
the reflector comprised of a continuous piece of rigid material in a roughly cylindrical shape possessing an interior and exterior surface, the reflector possessing a lampholder end and a reflector end, the interior surface of the reflector end coated with a reflective material, the lampholder end possessing an aperture connector,
the interior surface of the lampholder end of the reflector sized to fit snugly over the standard sockets used in incandescent and fluorescent light fixtures,
the reflector end of the reflector shaped in such a way as to concentrate a beam of light generated at the lampholder end into a concentrated beam exiting the reflector end of the reflector,
the trim rim a hollow piece of rigid material attached fixedly to the reflector end of the reflector, the trim rim extending outside the outer diameter of the reflector end of the reflector.

2. A ceiling light retrofit system as in claim 1 where the aperture connector is a circular hole that has the same diameter as a standard incandescent light socket.

3. A ceiling light retrofit system as in claim 1 where the aperture connector is an adaptor that is capable of being screwed into a standard incandescent light socket and is electrically connected to a replaceable CFI socket attached to the inside of the lampholder end.

4. A ceiling light retrofit system as in claim 3 where the trim rim possesses within its hollow interior a power control device and a sensor.

5. A ceiling light retrofit system as in claims 2 and 3, where the rigid material comprising the reflector is a selected from the list comprised of steel, aluminum, ceramic, and polymer plastic.

6. A method of using a ceiling light retrofit system as in claim 2, comprised of the steps of
identifying a fluorescent or incandescent bulb ceiling fixture to be retrofitted,
removing the fluorescent or incandescent bulb from its socket,
placing the ceiling light retrofit system over the socket by means of connecting the lampholder end of the reflector over the socket,
fitting the trim rim to the hole in the ceiling where the ceiling fixture is placed by pushing the ceiling light retrofit system down onto the socket until the trim rim meets the bottom surface of the ceiling, and tension springs lock the invention into place,
replacing the lamp in the socket.

7. A method of using a ceiling light retrofit system as in claim 3, comprised of the steps of
identifying a fluorescent or incandescent bulb ceiling fixture to be retrofitted,
removing the fluorescent or incandescent bulb from its socket,
placing the adaptor into the incandescent bulb socket,
fitting the trim rim to the hole in the ceiling where the ceiling fixture is placed by pushing the ceiling light retrofit system up into the fixture until the trim rim meets the bottom surface of the ceiling, and tension springs lock the invention into place,
placing a CFI in the socket.

8. A method of using a ceiling light retrofit system as in claims 6 and 7, adding an additional step of placing a silicon rubber gasket between the trim rim and the bottom surface of the ceiling directly before the step of fitting the trim rim to the hole in the ceiling.
